(19) United States
(12) Patent Application Publication
(10) Pub. No.: US 2004/0268033 A1
(43) Pub. Date: Dec. 30, 2004

(54) Refreshing data in a data storage device

(75) Inventors: KokHoe Chia, Singapore (SG); Teck Khoon Lim, Singapore (SG); SanYan Liew, Singapore (SG); BengWee Quak, Singapore (SG)

Correspondence Address: Robert M. Angus, Westman, Champlin & Kelly, Suite 1600, 900 Second Avenue South, Minneapolis, MN, 55402-3319, US

(73) Assignee: Seagate Technology LLC, Scotts Valley, CA

(21) Appl. No.: 10/602,975

(22) Filed: Jun. 24, 2003

(51) Int. Cl. G06F 12/08

(52) U.S. Cl. 711/112; 711/203

(57) ABSTRACT

Data on a storage medium are refreshed by reading the data from a first location on the storage medium, storing them to a second location, and reading the data from the second location and storing them at the first location. The first and second locations are first and second physical locations and a logical address is initially associated with the first physical location. When the data are stored at the second location, the association of the logical address is changed to the second physical location. When the data are stored again at the first location, the association of the logical address is changed to the first physical address. The process is performed iteratively on the basis of successive logical block addresses. If the storing the data at the first location is interrupted, the data is re-read from the second location, and re-stored to the first location.

### FIELD OF THE INVENTION

This invention relates to data storage devices.

### BACKGROUND OF THE INVENTION

As the emphasis continues for greater aerial density on data stored on storage media, a problem of data being lost due to thermal decay becomes a more serious problem. More particularly, the orientation of magnetic dipoles becomes increasingly unstable when the storage medium is exposed to elevated temperatures over time. The data is stored as reversals of orientation of magnetic dipoles, which are read as transitions in a signal recovered from the medium. As the aerial density of stored data becomes greater, the area on the stored medium for a transition becomes increasingly smaller, resulting in fewer dipoles defining the transition. Consequently, instability of even a few of the dipoles forming a single reversal of dipole orientation may result in degradation of the transition in the recovered signal, which results in degradation of the quality of the signal read from the medium. Degradation of signal quality may result in loss of data.

Magnetic storage devices, such as magnetic disc drives, tape drives and the like, have been designed on the assumption that signal degradation will not occur due to thermal decay. More particularly, the head/medium performance was optimized based on the assumption that thermal decay would not adversely affect the signal. However, higher aerial density leads to smaller transition regions, such that thermal decay may increase read error rates and adversely affect the performance of the storage medium. Ultimately, data loss may occur.

Alex, in U.S. Pat. No. 6,429,984 describes a technique for refreshing recorded data whereby under prescribed conditions, data are read from the medium and re-recorded back to the physical location from which they were read. One problem with the Alex approach is that if the refresh process is interrupted for any reason, the data being refreshed is likely to be lost. Thus, if an interrupt occurs to the refresh process, such as due to a read operation of the storage medium, the data read, but not re-written, may be lost and unrecoverable. Moreover, if a catastrophic event, such as a power failure, occurs during the refresh process, the data may be lost.

The present invention provides a solution to this and other problems, and offers other advantages over the prior art.

### SUMMARY OF THE INVENTION

In a first embodiment of the invention, data on a storage medium are refreshed by reading the data from a first location on the storage medium. The read data are stored to a second location, and the stored data are then read and stored at the first location.

In some embodiments, the first and second locations are first and second physical locations and a logical address is initially associated with the first physical location. When the data are stored at the second location, the association of the logical address is changed to the second physical location. When the data are stored again at the first location, the association of the logical address is changed to the first physical address.

In some embodiments, the process is performed iteratively on the basis of successive logical block addresses. If the storing the data at the first location is interrupted, the data is re-read from the second location, and re-stored to the first location.

In a second embodiment of the invention, a computer useable medium contains a computer readable program having executable program code for carrying out the process.

Other features and benefits that characterize embodiments of the present invention will be apparent upon reading the following detailed description and review of the associated drawings.

### BRIEF DESCRIPTION OF THE DRAWINGS

FIG. 1 is a perspective view of a disc drive in which aspects of the present invention may be practiced.

FIG. 2 is a flowchart of a process of refreshing data stored on a storage disc in the disc drive shown in FIG. 1.

FIGS. 3 and 4 are flowcharts illustrating the process of FIG. 2 following various interrupts.

### DETAILED DESCRIPTION OF ILLUSTRATIVE EMBODIMENTS

In accordance with the present invention, a test and data refresh operation is performed at predetermined intervals. The refresh operation will be performed on all data of each sector addressable by a logical block address (LBA). More particularly, data for each sector, starting from an initial LBA, are refreshed by writing the data to a designated spare sector. The data are then written back into the original location using the same data, and a read operation is performed to ensure that good data are written into the original location. Consequently, the sectors addressed by the logical block address are refreshed and problems with thermal decay are reduced. Sectors addressed by the next logical block address are refreshed using the same designated spare sector, which is overwritten with the data addressed by the new LBA.

The refresh process is performed at predetermined intervals, such as every six months, year or more. Predetermined intervals might also be determined empirically based on the thermal decay rate of the disc drive.

By employing the spare sector for temporary storage of data, the data are available in the event that the refresh process is interrupted by a read operation, and data may be recovered in the event of a catastrophic event.

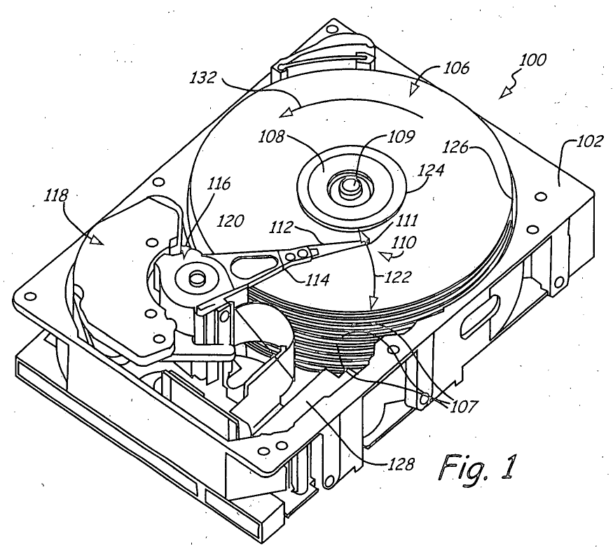

FIG. 1 is a perspective view of a disc drive 100 in which the present invention is useful. Disc drive 100 includes a housing with a base 102 and a top cover (not shown). Disc drive 100 further includes a disc pack 106, which is mounted on a spindle motor (not shown) by a disc clamp 108 for rotation in the direction of arrow 132. Disc pack 106 includes a plurality of individual magnetic recording discs 107, which are mounted for co-rotation about central axis 109. Each disc surface has an associated slider 110 that is mounted in disc drive 100 for communication with the confronting disc surface. Slider 110 is arranged to fly above the associated disc surface of an individual disc of disc pack 106, and carries a transducing head 111 arranged to write data to, and read data from, concentric tracks on the confronting disc surface. In the example shown in FIG. 1, sliders 110 are supported by suspensions 112 which are in turn attached to track accessing arms 114 of an actuator 116. Actuator 116 is driven by a voice coil motor (VCM) 118 to rotate the actuator, and its attached sliders 110, about a pivot shaft 120. Rotation of actuator 116 moves the heads along an arcuate path 122 to position the heads over a desired data track between a disc inner diameter 124 and a disc outer diameter 126.

Voice coil motor 118 is operated by position signals from servo electronics included on circuit board 128, which in turn are based on error signals generated by heads 111 and position signals from a host computer (not shown). Read and write electronics are also included on circuit board 128 to supply signals to the host computer based on data read from disc pack 106 by the read portions of heads 111, and to supply write signals to the write portions of heads 111 to write data to the discs.

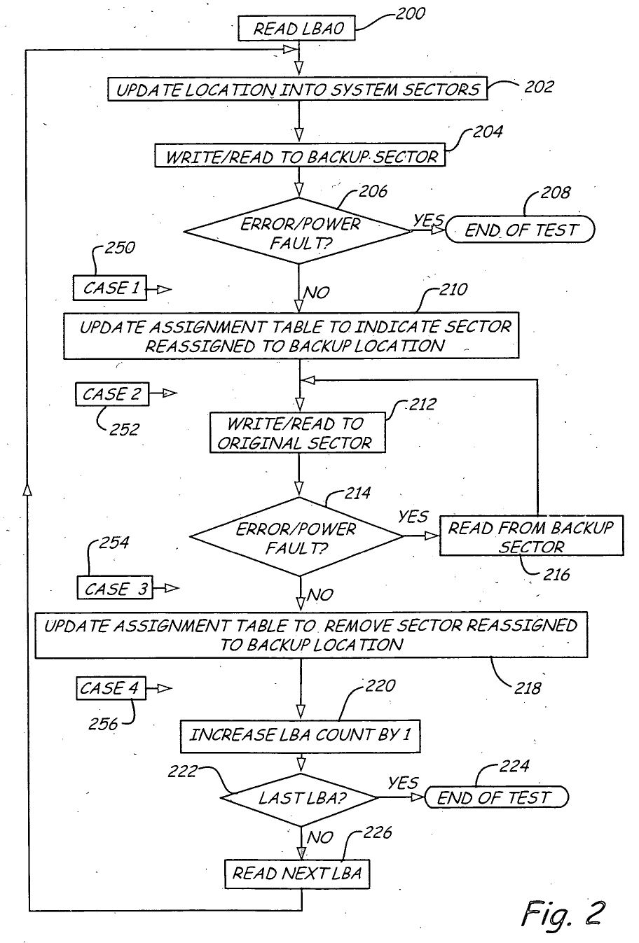

FIG. 2 is a flow chart illustrating the process of refreshing data in accordance with an embodiment of the present invention. The process is carried out within the disc drive, using program code according to the invention that becomes part of the self-diagnostics software of the disc drive. The process commences at step 200 where the first logical block address LBA0 is read. The logical block address is associated in tables (not shown) to a physical block address that addresses the physical location of the sector or sectors associated with the logical block address. Thus, the logical block address is the address of data used by software and routines outside of the disc drive to address desired data, whereas the physical block address is the address of the physical sector or sectors within the disc drive at which that data are stored. The logical-to-physical sector reassignment tables are located within the disc drive to correlate the logical to the physical addresses.

At step 202, the physical block address location is updated relative to the logical block address, and at step 204, data are read from the sector or sectors of a magnetic storage disc 111 (FIG. 1) commencing with the physical block address that corresponds to the logical block address. The data read from the addressed sector(s) are stored to a back-up sector(s), also on a disc 111, that is assigned to the refresh task. The back-up sector(s) may be sectors that are specifically dedicated to the refresh operation, or may be free sectors selected by the disc drive controller at the start of the refresh process.

At step 206, a test is performed to determine whether an error or power fault has occurred during the performance of steps 200 through 204. If an error or power fault has occurred, the test is ended at step 208 by an interrupt. If no error or power fault has occurred, at step 210 the logical-to-physical reassignment tables in the disc drive are updated to indicate that the logical block address for the data is reassigned to the physical block address of the back-up sector to which the data are written at step 204. At step 212, the data stored in the back-up sector are read and re-written back into the original physical address sector from which the data were read in step 204.

In the event that an error or power fault occurs, as detected at the step 214, the data are again read from the back-up sector at step 216 and are written to the original sector at step 212. If no fault is detected at step 214, the logical-to-physical reassignment tables are again updated at step 218 to indicate that the logical block address for the data is no longer assigned to the back-up location, but instead, is reassigned to the original physical address. At step 220, the logical block address count is increased by one, and at step 222 a determination is made as to whether the last logical block address has been addressed in the process. If the last logical block address has been addressed, all of the data on the disc drive has been refreshed, and the process ends at step 224. If it has not, the next logical block address (e.g., LBA1) is read at step 226 and the process loops back to step 202 to perform data refresh for the next logical block address.

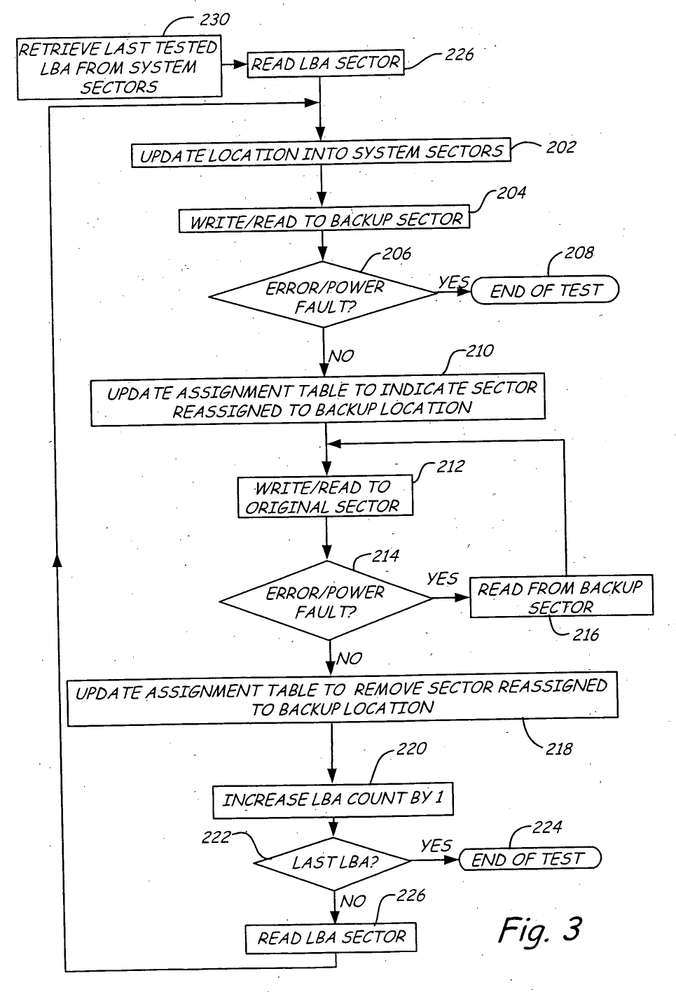

In preferred embodiments, the process is preferably performed in a plurality of four stages, each stage being permitted to be completed in the event of an interruption of the process. Thus, in the event of an interface command is received during a test, the current phase of the test will be completed and the test then terminated. Also, if the test is ended due to an error or power fault at step 208, recovery of the data being refreshed is accomplished. More particularly, as shown in FIG. 3, in the event that an interruption of the data refresh process occurs at point 250 (FIG. 1) before the logical-to-physical reassignment tables are updated at step 210, then the last tested logical block address is retrieved from the system sectors at step 230 and is read at step 226 for input to the updating step of step 202. More particularly, if the interruption occurs before performing step 210, the data being refreshed is still safely stored at the original physical location and the logical-to-physical reassignment tables still associate that physical location to the logical block address. Consequently, the interruption of the process at or before point 250 (FIG. 2) merely causes the system to re-start the refresh process commencing with the logical block address from which the process was interrupted. The system sector is read at step 230 to determine the last known location and the process commences from that location at step 226.

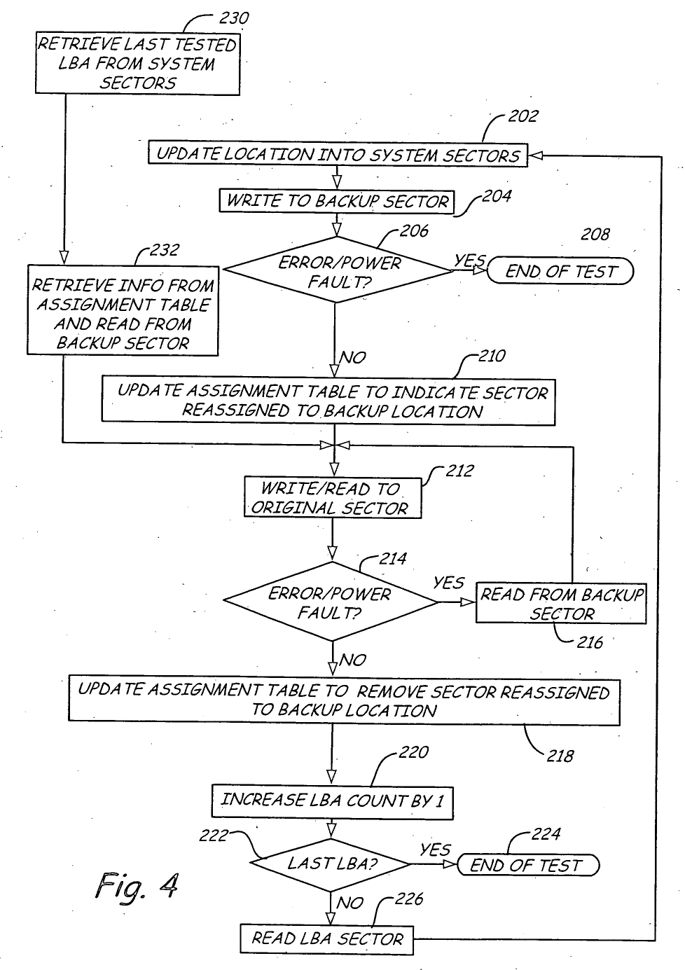

If an interruption occurs after the logical-to-physical sector reassignment tables are updated at step 210, as indicated at point 252 (FIG. 1), then as shown in FIG. 4, at the start of the next diagnostic test, the system sector is read at step 230 to identify the last logical block address. Since the logical block address is now associated with the physical address of the back-up sector, the data being refreshed are read from the back-up location at step 232 to write that data to the original sector at step 212.

Even if the data had been re-written to the original physical location, as at point 254 in FIG. 1 or if the reassignment tables had been updated to remove the back-up sector as associated with the logical block address, in one form of the invention, the process simply reenters the process of FIG. 1 between steps 210 and 212 and reads the data from the back-up sector at step 232 and writes the data to the original sector at step 212.

If the diagnostic routines are able to store confirmation of the completion of the phases of the refresh process, it may be possible to shorten the third and fourth phases such that if the interrupt occurs between points 252 and 254, the process might re-commence at step 218 to update the reassignment tables to remove the back-up sector as the physical sector assigned to the logical block address. If the process had been interrupted at point 256, the diagnostic routine might simply note that the process was completed and re-commence the process at step 256 by increasing the LBA count by one and ending the test (if data at the last LBA was refreshed) or executing the refresh test for the next LBA.

Although the present invention has been described with reference to magnetic disc drives, those skilled in the art will recognize that the present invention may be practiced with other data storage systems, including but not limited to tape drive and re-writable optical disc drives, as well as systems employing other data storage technologies where data quality degrades due to environmental conditions or time.

It is to be understood that even though numerous characteristics and advantages of various embodiments of the present invention have been set forth in the foregoing description, together with details of the structure and function of various embodiments of the invention, this disclosure is illustrative only, and changes may be made in details, especially in matters of structure and arrangement of parts within the principles of the present invention to the full extent indicated by the broad general meaning of the terms in which the appended claims are expressed. For example, particular elements may vary depending on the particular application for the data refresh technique while maintaining substantially the same functionality without departing from the scope and spirit of the present invention. Thus, while the invention is described in connection with magnetic storage media, the data refresh process might be applied to other technologies. Additionally, although the invention is described herein is directed to use with the self diagnostics of the data storage device, it will be appreciated by those skilled in the art that the process of the present invention may be performed upon elapsed times, such as each six months or year based on calendar time, or upon some number of hours of use of the storage device, or it may be performed based on environmental conditions to which the storage device is subjected, without departing from the scope and spirit of the invention. Also, while the invention is described as being performed by the storage device, the storage device controller or the computer with which the storage device operates may perform parts of the process, and the process may be performed under the control of a computer program that is resident on the storage medium, such as a disc 111 (FIG. 1), or may be resident in a read only memory (ROM) associated with the storage device, storage device controller or computer. While the invention has been described as employing spare sectors on the storage medium to temporarily store data while being refreshed, temporary storage may be accomplished in other media than the medium being refreshed.

What is claimed is:

1. A process of refreshing data on a storage medium comprising steps of:
reading data from a first location on the storage medium;
storing the data at a second location; and
storing the data at the first location.

2. The process of claim 1, further including:
reading the data from the second location before storing the data at the first location.

3. The process of claim 1, wherein the first and second locations are first and second physical locations and a logical address is initially associated with the first physical location, and the step of storing the data at the second location includes:
changing the association of the logical address to the second physical location.

4. The process of claim 3, wherein the step of storing the data at the first location includes:
changing the association of the logical address to the first physical location.

5. The process of claim 3, further including:
reading the data from the second location before storing the data at the first location.

6. The process of claim 5, wherein the step of storing the data at the first location includes:
changing the association of the logical address to the first physical location.

7. The process of claim 3 performed iteratively on the basis of successive logical block addresses, and wherein if the step of storing the data at the first location is interrupted,
reading the data from the second location, and
storing the read data to the first location.

8. The process of claim 7, wherein the step of storing the data at the first location includes:
changing the association of the logical address to the first physical location.

9. A computer useable medium having a computer readable program embodied therein for addressing data to refresh data stored on a storage medium, the computer readable program comprising:
first computer readable program code for causing the computer to read data from a first location on the storage medium;
second computer readable program code for causing the computer to store the data at a second location; and
third computer readable program code for causing the computer to store the data at the first location.

10. The computer useable medium of claim 9, wherein the third program code includes:
computer readable program code for causing the computer to read the data from the second location, and
computer readable program code responsive to the read data from the second location to cause the computer to store the data at the first location.

11. The computer useable medium of claim 9, wherein the first and second locations are first and second physical locations and a logical address is initially associated with the first physical location, and the second program code includes:
computer readable program code for causing the computer to change the association of the logical address to the second physical location.

12. The computer useable medium of claim 11, wherein the third program code includes:
computer readable program code for causing the computer to change the association of the logical address to the first physical location.

13. The computer useable medium of claim 11, further including:
computer readable program code for causing the computer to read the data from the second location before executing the computer readable program code that causes the computer to store the data at the first location.

14. The computer useable medium of claim 13, wherein the first computer readable program code includes:
computer readable program code for causing the computer to change the association of the logical address to the first physical location.

15. The computer useable medium of claim 11, wherein the computer readable program is executed iteratively on the basis of successive logical block addresses, and the computer readable program further includes:
computer readable program code responsive to interruption of the execution of the first computer readable program code for causing the computer to read the data from the second location, and
computer readable program code for causing the computer to store the read data to the first location.

16. The computer useable medium of claim 15, wherein the computer readable program code that causes the computer to store the data at the first location includes:
computer readable program code for causing the computer to change the association of the logical address to the first physical location.

17. A data storage device comprising a magnetic disc drive having a rotatable magnetic disc medium containing a plurality of addressable storage sectors for storing data, a table associating logical addresses to physical addresses of the storage sectors, and a processor for controlling operation of the disc drive, the disc drive containing executable program code to refresh data stored in storage sectors, the executable program code including:
first program code responsive to a logical block address for causing the processor to read data from a first location on the storage medium;
second program code for causing the processor to store the data at a second location;
third program code responsive to the successful storage of the data at the second location for causing the processor to change the association of the logical address to the second location;
fourth program code responsive to the logical block address for causing the processor to read the data from the second location;
fifth program code responsive to the data read from the second location to cause the processor to store the data at the first location; and
sixth program code responsive to the successful storage of the data at the first location for causing the processor to change the association of the logical address to the first location.

18. The data storage device of claim 17, wherein the executable program code includes program code for iteratively executing the first through sixth program codes for each logical block address.
